(19) United States
(12) Patent Application Publication
(10) Pub. No.: US 2026/0127590 A1
(43) Pub. Date: May 7, 2026

(54) APPLICATION OF THE LAWS OF THERMODYNAMICS IN MONITORING THE DYNAMICS OF ACCOUNT-TO-ACCOUNT TRANSACTION SYSTEMS

(71) Applicant: Mastercard International Incorporated, Purchase, NY (US)

(72) Inventors: Saeed Mirshekari, O'Fallon, MO (US); Mahdi Jadaliha, Wildwood, MO (US)

(73) Assignee: Mastercard International Incorporated, Purchase, NY (US)

(21) Appl. No.: 18/940,617

(22) Filed: Nov. 7, 2024

(51) Int. Cl. G06Q 20/38; G06Q 20/40

(52) U.S. Cl. CPC G06Q 20/389; G06Q 20/4016

(57) ABSTRACT

A system, computer-readable media and computer-implemented method for applying the laws of thermodynamics in monitoring the dynamics of account-to-account transaction systems. The computer-implemented method includes: receiving, from a data source, raw transaction records, each raw transaction record including a sender identifier (ID), recipient ID, an amount, and a fraud flag; extracting the sender ID, the recipient ID, and the fraud flag for each financial transaction; generating, based on the extracted information: sender transaction records; and recipient transaction; merging the sender transaction records and the recipient transaction records into potentially fraudulent transaction records and non-fraudulent transaction records; calculating a first transaction mass of the potentially fraudulent transaction records and a second transaction mass of the non-fraudulent transaction records; and calculating a first transaction velocity of the potentially fraudulent transaction records and a second transaction velocity of the non-fraudulent transaction records.

### FIELD OF THE INVENTION

The present disclosure generally relates to systems, computer-readable media and computer-implemented methods for applying the laws of thermodynamics in monitoring the dynamics of account-to-account (A2A) transaction systems.

### BACKGROUND

Monitoring patterns of behavior associated with fraudulent transactions typically involves computationally complex calculations that use a significant amount of computational and financial resources. For example, monitoring patterns of fraudulent behavior may involve memory intensive data transformations that consume significant amounts of electrical energy. Moreover, data used to monitor the patterns of fraudulent behavior may be days or weeks old, which can hinder the ability to detect fraud in real time.

Moreover, account-to-account (A2A) transaction systems are particularly vulnerable to fraudulent transactions, as funds may be transferred directly from one account to another with minimal oversight.

### BRIEF SUMMARY

In a first aspect, a system for applying the laws of thermodynamics in monitoring the dynamics of account-to-account transaction systems may be provided. The system may comprise a server. The server may include a communication element, a memory element, and a processing element which executes a software application. The software application may include instructions to: receive, from a data source, raw transaction records corresponding to financial transactions, each of the raw transaction records including a sender identifier (ID), a recipient ID, a timestamp, an amount, and a fraud flag relating to a likelihood of fraud in the corresponding one of the financial transactions; extract, from the raw transaction records, the sender ID, the recipient ID, and the fraud flag for each of the financial transactions; generate, based on the sender ID, the recipient ID, and the fraud flag extracted for each of the raw transaction records: sender transaction records including non-fraudulent sender transaction records and potentially fraudulent sender transaction records; and recipient transaction records including non-fraudulent recipient transaction records and potentially fraudulent recipient transaction records; merge the sender transaction records and the recipient transaction records into potentially fraudulent transaction records and non-fraudulent transaction records; calculate a first transaction mass of the potentially fraudulent transaction records for each sender ID and recipient ID and a second transaction mass of the non-fraudulent transaction records for each sender ID and recipient ID; and calculate a first transaction velocity of the fraudulent transaction records and a second transaction velocity of the non-fraudulent transaction records. The system may include additional, less, or alternate functionality, including that discussed elsewhere herein.

In another aspect, a computer-implemented method for applying the laws of thermodynamics in monitoring the dynamics of account-to-account transaction systems may be provided. The computer-implemented method may include: receiving, from a data source, raw transaction records corresponding to financial transactions, each raw transaction record including a sender identifier (ID), recipient ID, an amount, and a fraud flag relating to a likelihood of fraud in the corresponding one of the financial transactions; extracting, from the raw transaction records, the sender ID, the recipient ID, and the fraud flag for each of the financial transactions; generating, based on the sender ID, the recipient ID, and the fraud flag extracted for each of the raw transaction records: sender transaction records including non-fraudulent sender transaction records and potentially fraudulent sender transaction records; and recipient transaction records including non-fraudulent recipient transaction records and potentially fraudulent recipient transaction records; merging the sender transaction records and the recipient transaction records into potentially fraudulent transaction records and non-fraudulent transaction records; calculating a first transaction mass of the potentially fraudulent transaction records and a second transaction mass of the non-fraudulent transaction records; and calculating a first transaction velocity of the potentially fraudulent transaction records and a second transaction velocity of the non-fraudulent transaction records. The method may include additional, less, or alternate actions, including those discussed elsewhere herein.

In still another aspect, a system for applying the laws of thermodynamics in monitoring the dynamics of account-to-account transaction systems may be provided. The system may include a non-transitory computer-readable medium with a program stored thereon, wherein the program instructs one or more hardware processing elements to: receive, from a data source, raw transaction records corresponding to financial transactions, each of the raw transaction records including a sender identifier (ID), a recipient ID, a timestamp, an amount, and a fraud flag relating to a likelihood of fraud in the corresponding one of the financial transactions; extract, from the raw transaction records, the sender ID, the recipient ID, and the fraud flag for each of the financial transactions; generate, based on the sender ID, the recipient ID, and the fraud flag extracted for each of the raw transaction records: sender transaction records including non-fraudulent sender transaction records and potentially fraudulent sender transaction records; and recipient transaction records including non-fraudulent recipient transaction records and potentially fraudulent recipient transaction records; merge the sender transaction records and the recipient transaction records into potentially fraudulent transaction records and non-fraudulent transaction records; calculate a first transaction mass of the potentially fraudulent transaction records for each sender ID and recipient ID and a second transaction mass of the non-fraudulent transaction records for each sender ID and recipient ID; and calculate a first transaction velocity of the potentially fraudulent transaction records and a second transaction velocity of the non-fraudulent transaction records. The program(s) stored on the computer-readable medium may instruct the processing elements to perform additional, fewer, or alternative actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts one or more embodiments of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which various embodiments of a server system, configured for applying the laws of thermodynamics in monitoring the dynamics of account-to-account (A2A) transaction systems, may operate, the exemplary environment including a communication network that allows communication with various computing devices;

FIG. 2 illustrates various exemplary components of the server system of FIG. 1, shown in block schematic form;

FIG. 3 illustrates various exemplary components of a computing system corresponding to the data sources and client computing devices of FIG. 1;

FIGS. 4A and 4B illustrate various exemplary visualizations of a transaction mass generated by the server system of FIG. 1;

FIGS. 5A and 5B illustrate various exemplary visualizations of a transaction velocity generated by the server system of FIG. 1;

FIG. 6 illustrates an exemplary process for applying the laws of thermodynamics in monitoring the dynamics of A2A transaction systems performed by the server system of FIG. 1; and

FIG. 7 illustrates an exemplary process for rendering visualizations of the dynamics of A2A transaction systems performed by the server system of FIG. 1.

### DETAILED DESCRIPTION

Embodiments of the present technology relate to systems, computer-readable media and computer-implemented methods for applying the laws of thermodynamics in monitoring the dynamics of account-to-account transaction systems. Embodiments of the present technology provide real time monitoring for fraudulent transactions and identification of patterns of fraudulent behavior.

According to one or more embodiments, dynamic transaction monitoring software includes instructions for monitoring the dynamics of account-to-account (A2A) transaction systems in real time by applying the laws of thermodynamics. The dynamic transaction monitoring software may utilize various data fields extracted from raw transaction data to calculate dynamic metrics, such as a transaction mass, a transaction velocity, and a transaction energy, for potentially fraudulent transaction records and non-fraudulent transaction records. The dynamic transaction monitoring software may additionally generate one or more visualizations of the dynamic metrics. The one or more visualizations may be generated based on user-selectable parameters. The visualizations may reveal patterns of fraudulent behavior transaction records compared to non-fraudulent transaction records in ways previously unavailable.

For example, the dynamic transaction monitoring software may receive raw transaction records from one or more data sources. Each raw transaction record may correspond to a financial transaction. In some embodiments, the data sources may be associated with one or more A2A transaction services, one or more person-to-person (P2P) transaction services, and/or one or more entities associated with user accounts that utilize the one or more A2A transaction services or P2P transaction services. The data sources may also or alternatively be associated with account-to-business (A2B) transaction services, business-to-business (B2B) transaction services, merchants, financial institutions, and/or individuals. The dynamic transaction monitoring software may extract relevant information from the raw transaction records including, for example, sender identifiers (IDs), recipient identifiers (IDs), fraud flags, transaction amounts, timestamps, and the like.

The dynamic transaction monitoring software may separate the raw transaction records into sender transaction records and recipient transaction records based on the extracted sender IDs, recipient IDs, and fraud flags. The sender transaction records may include potentially fraudulent sender transaction records and non-fraudulent sender transaction records. The fraud flags include or comprise an indication of whether a particular transaction record is associated with fraud or is potentially fraudulent. The recipient transaction records may include potentially fraudulent recipient transaction records and non-fraudulent recipient transaction records, as indicated by the fraud flags. The dynamic transaction monitoring software may separate potentially fraudulent transaction records from non-fraudulent transaction records based on a value of the fraud flag for each transaction record. One of ordinary skill will appreciate that an operation to separate out or extract, according to this disclosure, may comprise merely designating the respective items or datums for separate treatment or otherwise delineating between the respective items or datums (e.g., using metadata), and need not (but may) include physical or logical partitions or removal from related memory.

The dynamic transaction monitoring software may generate sender transaction records based on the potentially fraudulent sender transaction records and the non-fraudulent sender transaction records. The combined sender transaction records may include combined potentially fraudulent sender transaction records and combined non-fraudulent sender transaction records. The combined potentially fraudulent sender transaction records may be generated based on the potentially fraudulent sender transaction records. The combined non-fraudulent sender transaction records may be generated based on the non-fraudulent sender transaction records. Each combined potentially fraudulent sender transaction record may include an aggregation of potentially fraudulent sender transaction records associated with a particular sender ID. Each combined non-fraudulent sender transaction record may include an aggregation of non-fraudulent sender transaction records associated with a particular sender ID. Each combined potentially fraudulent sender transaction record may be generated by identifying and aggregating potentially fraudulent sender transaction records associated with a particular sender ID. Each combined non-fraudulent sender transaction record may be generated by identifying and aggregating non-fraudulent sender transaction records associated with a particular sender ID. Each combined sender transaction record may include the sender ID, an entity associated with the sender ID, a total amount transacted, a count of transaction records, a time period associated with timestamps of the transaction records, a fraud flag indication, and the like. An entity associated with each sender ID may be a financial institution where a user associated with the sender ID holds a financial account, or another entity related in some way to the transaction(s).

The dynamic transaction monitoring software may generate combined recipient transaction records based on the potentially fraudulent recipient transaction records and the non-fraudulent recipient transaction records. The combined recipient transaction records may include combined potentially fraudulent recipient traction records and combined non-fraudulent recipient transaction records. The combined potentially fraudulent recipient transaction records may be generated based on the potentially fraudulent recipient transaction records. The combined non-fraudulent recipient transaction records may be generated based on the non-fraudulent recipient transaction records. Each combined potentially fraudulent recipient transaction record may include an aggregation of potentially fraudulent recipient transaction records associated with a particular recipient ID. Each combined non-fraudulent recipient transaction record may include an aggregation of non-fraudulent recipient transaction records associated with a particular recipient ID. Each combined potentially fraudulent recipient transaction record may be generated by identifying and aggregating potentially fraudulent recipient transaction records associated with a particular recipient ID. Each combined non-fraudulent recipient transaction record may be generated by identifying and aggregating non-fraudulent recipient transaction records associated with a particular recipient ID. Each combined recipient transaction record may include the recipient ID, an entity associated with the recipient ID, a total amount transacted, a count of transaction records, a time period associated with timestamps of the transaction records, a fraud flag indication, and the like. An entity associated with each recipient ID may be a financial institution where a user associated with the recipient ID holds a financial account, or another entity related in some way to the transaction(s).

Moreover, the combined sender transaction records and combined recipient transaction records—that is, combined transaction records representing aggregations of multiple transaction records according to the description above-may be delineated or represented separately based on one or more time periods. For example, a first combined sender transaction record may be a combined non-fraudulent sender transaction record including an aggregation of non-fraudulent sender transaction records associated with a first sender ID and a first time period. A second combined sender transaction may be a combined potentially fraudulent sender transaction record including an aggregation of potentially fraudulent sender transaction records associated with the first sender ID and the first time period. A third combined sender transaction record may be a potentially fraudulent sender transaction including an aggregation of potentially fraudulent sender transaction records associated with the first sender ID and a second time period subsequent to the first time period, and so on and so forth. Time periods may or may not overlap and each may include a day, a month, a year, and/or a user-selectable time range.

The dynamic transaction monitoring software may generate merged transaction records based on the combined sender transaction records and the combined recipient transaction records. The merged transaction records may include potentially fraudulent transaction records and non-fraudulent transaction records. The potentially fraudulent transaction records and non-fraudulent transaction records may be generated based on the combined sender transaction records and the combined recipient transaction records. The potentially fraudulent transaction records and non-fraudulent transaction records may be generated by matching sender IDs included in the combined sender transaction records with recipient IDs included in the combined recipient transaction records (or vice-versa). Combined sender transaction records and combined recipient transaction records having matching sender and recipient IDs may be combined into the potentially fraudulent transaction records and the non-fraudulent transaction records.

More particularly, the dynamic monitoring software may generate the potentially fraudulent transaction records of the merged transaction records by merging the combined potentially fraudulent sender transaction records of the combined sender transaction records with the combined potentially fraudulent recipient transaction records of the combined recipient transaction records. The dynamic monitoring software may generate the non-fraudulent transaction records of the merged transaction records by merging the combined non-fraudulent sender transaction records of the combined sender transaction records with the combined non-fraudulent recipient transaction records of the combined recipient transaction records.

The dynamic monitoring software may generate customer IDs based on matching sender IDs with recipient IDs. Each customer ID may identify a matched sender ID and recipient ID pair. The potentially fraudulent transaction records and the non-fraudulent transaction records may each include an aggregation of combined sender transaction records and combined recipient transaction records having matching customer IDs and fraud flags. For example, a first non-fraudulent transaction record may include an aggregation of combined non-fraudulent sender transaction records associated with a first customer ID and combined non-fraudulent recipient transaction records associated with the first customer ID.

Moreover, the potentially fraudulent transaction records and the non-fraudulent transaction records may be delineated or represented separately based on one or more time periods. For example, a first potentially fraudulent transaction record associated with a first customer ID may include an aggregation of combined potentially fraudulent sender transaction records and combined potentially fraudulent recipient transaction records associated with a first time period. A second potentially fraudulent transaction record associated with the first customer ID may include an aggregation of combined potentially fraudulent sender transaction records and combined potentially fraudulent recipient transaction records associated with a second time period subsequent to the first time period. A non-fraudulent transaction record associated with the first customer ID may include an aggregation of combined non-fraudulent sender transaction records and combined non-fraudulent recipient transaction records associated with the first time period.

The fraudulent transaction records and the non-fraudulent transaction records may each include a customer ID corresponding to the matching sender IDs and recipient IDs, an organization ID, a time period associated with timestamps of the transaction records, an amount of currency received, an amount of currency spent, a recipient transaction count, a sender transaction count, and a fraud flag. The organization ID may correspond to an entity associated with the customer ID and may be a financial institution where a user associated with the customer ID holds an account. Each time period may or may not overlap and may include a day, a month, a year, and/or a user-selectable time range. The recipient transaction counts may indicate a number of transactions in which currency was received by an account associated with a particular customer ID. The sender transaction counts may indicate a number of transactions in which currency was transferred away from an account associated with a particular customer ID.

The dynamic transaction monitoring software may calculate dynamic metrics based on the potentially fraudulent transaction records and the non-fraudulent transaction records. The dynamic metrics may be separated based on one or more time periods and the fraud flags. The dynamic metrics may include a transaction mass, a transaction velocity, and a transaction energy for each merged transaction record. For example, for each time period, potentially fraudulent transaction records associated with a particular customer ID may include a first transaction mass, a first transaction velocity, and a first transaction energy. In this example, non-fraudulent transaction records associated with a particular customer ID may include a second transaction mass, a second transaction velocity, and a second transaction energy for each time period. A value of each transaction mass may include a sum of an amount of currency transacted. A value of each transaction velocity may include a sum of recipient transaction counts and sender transaction counts for a given time period. A value of each transaction energy may include one half of the transaction mass multiplied by the square of the transaction velocity for a given time period.

In some embodiments, the dynamic transaction monitoring software may generate a visualization of the dynamic metrics based on user-selectable parameters. The user selectable parameter may include a total transaction mass, a total transaction velocity, a total transaction energy, an average transaction mass, an average transaction velocity, an average transaction energy, a time period of interest associated with a timestamp of each transaction record, one or more customer IDs, one or more entities, and the like.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

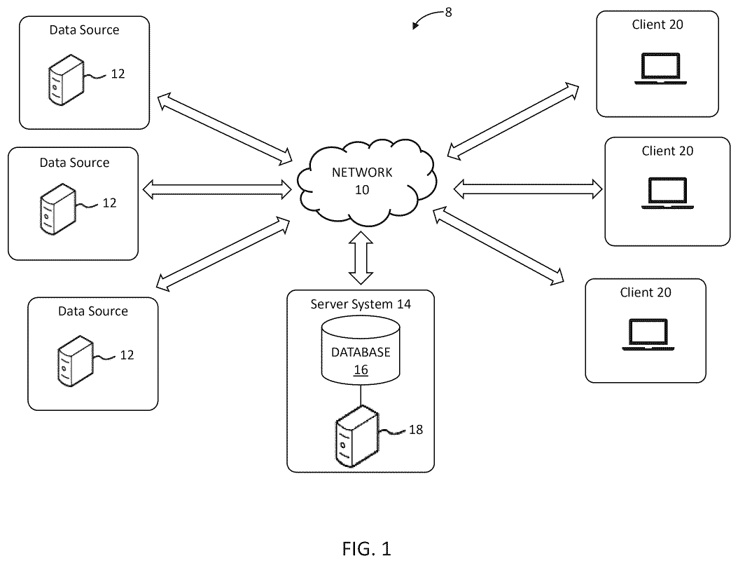

FIG. 1 depicts an example environment 8 for applying the laws of thermodynamics in monitoring the dynamics of account-to-account (A2A) transaction systems. The environment 8 includes a communication network 10, one or more data sources 12, a server system 14, and one or more client computing devices 20. Such data sources 12 and client computing devices 20 may each include a desktop computer, a laptop or tablet computer, a smartphone or similar devices configured to provide users access to the Internet via internet browser applications. The communication network 10 may provide wired and/or wireless communication between the client computing devices 20, the data sources 12, and the server system 14. The server system 14 may receive transaction record data reported by the data sources and generate visualizations of dynamic metrics associated with the transaction record data. The server system 14 may provide the visualizations to the client computing devices 20.

In some embodiments, the data sources 12 may be associated with one or more A2A transaction services, one or more person-to-person (P2P) transaction services, and/or one or more entities associated with accounts that utilize the one or more A2A transaction services or P2P transaction services. The data sources 12 may be part of an enterprise network associated with one or more A2A transaction systems and may include computing devices for reporting transaction data. In some embodiments, the data sources 12 may be associated with account-to-business (A2B) transaction services, business-to-business (B2B) transaction services, merchants, financial institutions, and/or individuals.

In some embodiments, transaction data may be reported by the data sources automatically on a periodic or rolling basis. Alternatively or additionally, transaction data may be reported by the data sources automatically based on one or more triggering events. In some embodiments, a human operator may provide input to instruct one or more of the data sources 12 to report the transaction data.

In some embodiments, the data sources 12 may be configured to encrypt raw transaction data before transmitting the transaction data to the server system 14. The raw transaction data may be encrypted using a private key of a public/private key pair associated with one or more of the data sources 12. It would be appreciated by one of ordinary skill in the art that various encryption devices and techniques, such as advanced encryption standard (AES) algorithm(s), hardware security module(s) (HSM), symmetric encryption algorithm(s), asymmetric encryption algorithm(s), Rivest-Shamir-Adleman (RSA) encryption algorithms, hybrid encryption algorithm(s), and the like, may be employed within the scope of the present invention.

Each of the data sources 12, the server system 14, and the client computing devices 20 may be configured to send data to and/or receive data from network 10 using one or more suitable communication protocols, which may be the same communication protocols or different communication protocols as one another. To provide an example, data sources 12, the server system 14, and the client computing devices 20 may each be configured to communicate via a direct radio link, which may utilize, for example, a Wi-Fi direct protocol, an ad-hoc cellular communication protocol, etc.

The communication network 10 generally allows communication between the data sources 12, the server system 14, and the client computing devices 20, such as via wireless communication and data transmission over one or more radio links. The communication network 10 may include one or more telecommunication networks, nodes, and/or links used to facilitate data exchanges between one or more devices and may facilitate a connection to the Internet for devices configured to communicate with network 10. The communication network 10 may include local area networks, metro area networks, wide area networks, cloud networks, the Internet, cellular networks, plain old telephone service (POTS) networks, and the like, or combinations thereof.

The communication network 10 may be wired, wireless, or combinations thereof and may include components such as modems, gateways, switches, routers, hubs, access points, repeaters, towers, and the like. The data sources 12, the server system 14, and the client computing devices 20 may connect to the communication network 10 either through wires, such as electrical cables or fiber optic cables, or wirelessly, such as radio frequency (RF) communication using wireless standards such as cellular 2G, 3G, 4G or 5G, Institute of Electrical and Electronics Engineers (IEEE) 802.11 standards such as Wi-Fi, IEEE 802.16 standards such as WiMAX, Bluetooth™, or combinations thereof. In aspects in which network 10 facilitates a connection to the Internet, data communications may take place over the network 10 via one or more suitable Internet communication protocols. For example, network 10 may be implemented as a wireless telephony network (e.g., GSM, CDMA, LTE, etc.), a Wi-Fi network (e.g., via one or more IEEE 802.11 Standards), a WiMAX network, a Bluetooth network, etc.

The server system 14 generally retains electronic data and may respond to requests to retrieve data, as well as to store data. The server system 14 may comprise and/or work in conjunction with application servers, database servers, file servers, gaming servers, mail servers, print servers, or the like, or combinations thereof. Furthermore, the server system 14 may include a plurality of servers, virtual servers, or combinations thereof. The server system 14 may be configured to include or execute software, such as file storage applications, database applications, email or messaging applications, server system applications, or the like. The server system 14 may include a database 16. The database 16 may include transaction data and/or software instructions for monitoring the dynamics of A2A transaction systems using the laws of thermodynamics. The server system 14 may be configured to store the transaction data in the database 16. The transaction data may include raw transaction records, extracted information, user profiles, organization information, calculated dynamic metrics, generated visualizations, and/or any other data relevant to monitoring the dynamics of A2A transaction systems using the laws of thermodynamics.

The server system 14 may be configured to receive raw transaction records from one or more of the data sources 12 via the network 10 and generate visualization of dynamic metrics associated with the raw transaction records. In some embodiments, the raw transaction records may be encrypted. In these embodiments, the server system 14 may be configured to decrypt the raw transaction records using a public key of the public/private key pair associated with one or more of the data sources 12. The server system 14 may be configured to extract relevant information from the raw transaction records. The extracted information may include, for example, sender identifiers (IDs), recipient identifiers (IDs), organization identifiers (IDs), fraud flags, transaction amounts, timestamps, and the like. The server system 12 may be configured to calculate the dynamic metrics based on the raw transaction records. The dynamic metrics may include a transaction mass, a transaction velocity, and a transaction energy for each sender ID, recipient ID, and/or organization ID. The organization IDs may correspond to one or more financial institutions or entities associated with an account identified by a recipient ID and/or sender ID. Each transaction mass, transaction velocity, and transaction energy may be or be associated with one or more values. The server system 14 may be configured to separate the dynamic metrics based on one or more time periods and the fraud flags of each transaction record.

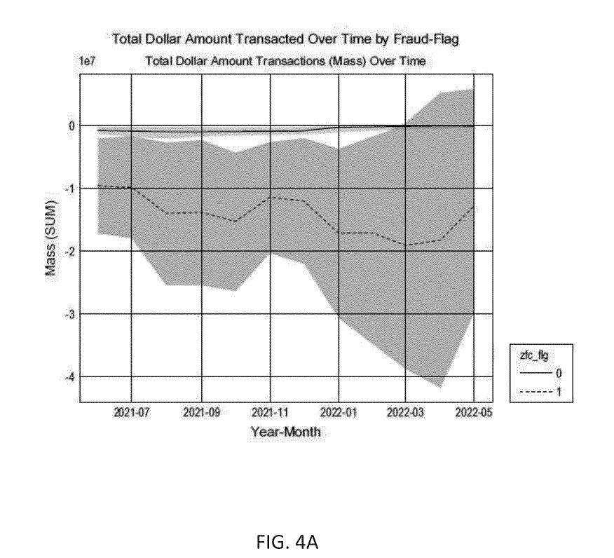

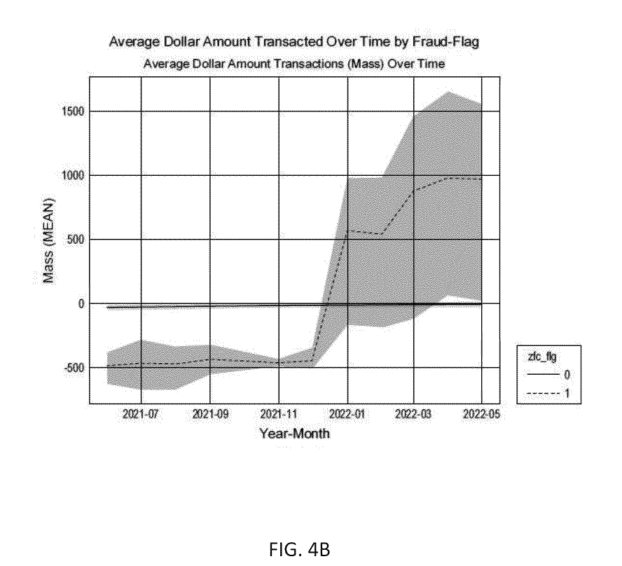

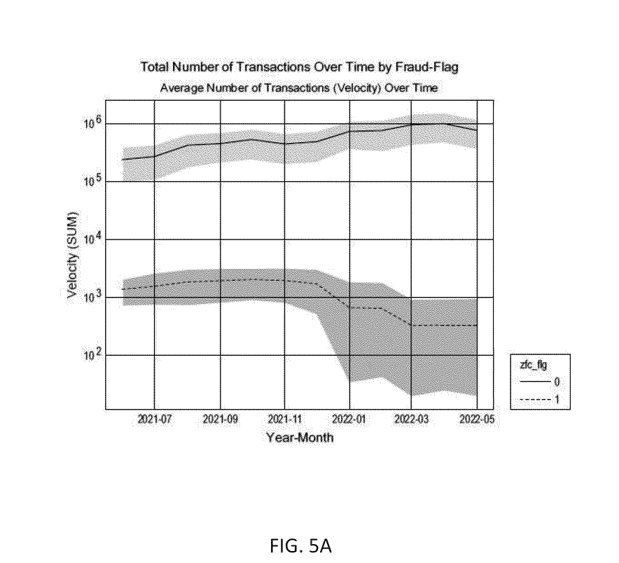

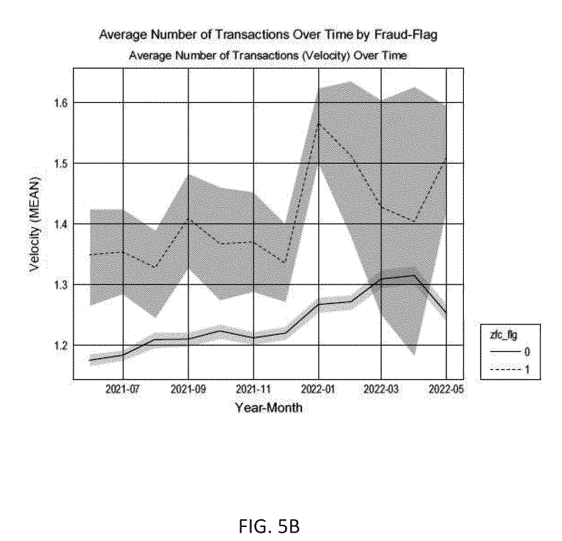

The server system 14 may be configured to receive a selection of user-selectable parameters from one or more of the client computing devices 20 via the network 10. The user-selectable parameters may include, for example, one or more time periods of interest, a transaction type, a total transaction mass, an average transaction mass, a total transaction velocity, an average transaction velocity, a total transaction energy, an average transaction energy, one or more organization IDs, a fraud flag indication, one or more customer IDs, and the like. The server system 14 may be configured to generate one or more visualizations of the dynamic metrics based on the selection(s) of the user-selectable parameters. In some embodiments, the server system 14 may be configured to generate one or more default visualizations if no selection of user-selectable parameters is received and/or if user selections are to be used to adjust or revise the visualization(s) downstream at the level of the client computing device 20. The default visualizations may include, for example, one or more of a total transaction mass over time (as shown in FIG. 4A) and/or a total transaction velocity over time (as shown in FIG. 5A).

In one or more embodiments, one or more of the client computing devices 20 and/or server system 14 may be configured to analyze the visualization(s) to identify patterns of fraudulent behavior associated with potentially fraudulent transaction records. In some embodiments, one or more of the client computing devices 20 and/or server system 14 may be configured to automatically analyze the visualization(s) using, for example, a machine learning model. Alternatively or additionally, the visualization(s) may be analyzed manually by a human operator.

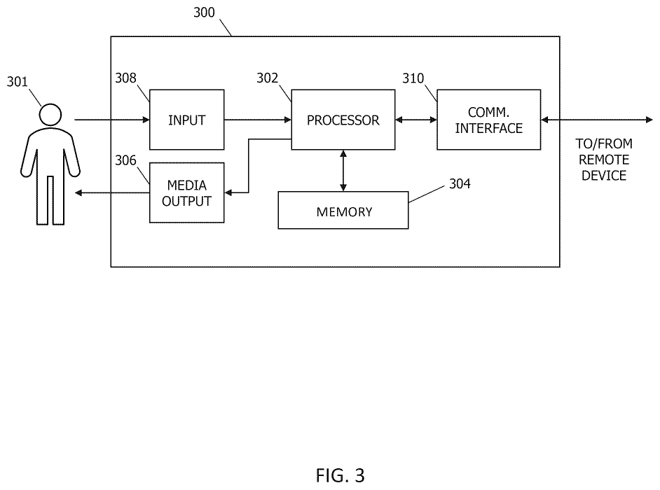

The client computing devices 20 may be configured to receive the selection(s) of the user-selectable parameters via an input device (e.g. the input device 308 shown in FIG. 3). The client computing devices may be configured to send the selection(s) of the user-selectable parameters to the server system 14 via the network 10 and/or locally adjust data and/or visualizations received from the server system 14 according to the user-selected parameters. The client computing devices 20 may be further configured to receive the visualizations from the server system 14 via the network 10. The client computing devices 20 may include a display (e.g. media output component 306 shown in FIG. 3). The client computing devices 20 may be configured to render a graphical user interface (GUI) on the display. The GUI may present one or more actionable items for enabling a user (e.g. the user 301 shown in FIG. 3) to select one or more of the user-selectable parameters via the input device. The actionable items may include one or more buttons, one or more icons, a drop-down menu, one or more selectable textual descriptions, and the like. The actionable items may include instructions to make adjustments to the visualizations (which, again, may be made locally and/or at the server system 14), instructions to perform analyses for fraud identification, or other actions or objects.

### Exemplary Server System

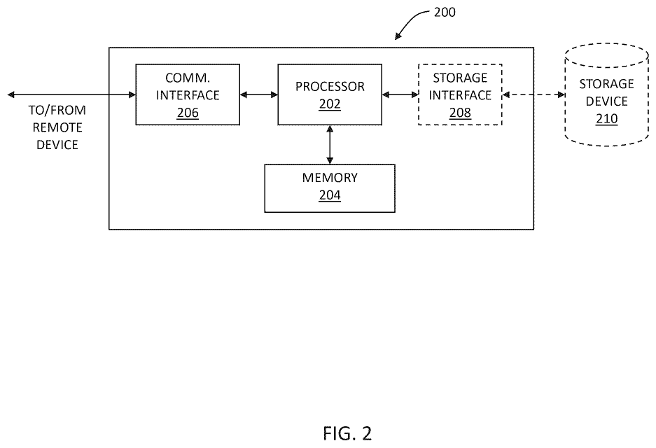

FIG. 2 is an example configuration of a server system 200, such as the server system 14 (shown in FIG. 1). The server system 200 includes, but is not limited to, a database 16 (shown in FIG. 1) and one or more computing devices 18 (shown in FIG. 1). In the example embodiment, the server system 200 includes a processor 202 for executing instructions. The instructions may be stored in a memory area 204, for example. In some embodiments, executable instructions, including instructions for executing the dynamic monitoring software, are stored in a memory device 204. The memory device 204 is any device allowing information such as dynamic metric visualization data, executable instructions, and/or written works to be stored and retrieved. The memory device 204 includes one or more computer readable media. The processor 202 includes one or more processing units (e.g., in a multi-core configuration) for executing the instructions. The instructions may be executed within a variety of different operating systems on the server system 200, such as operating systems sold under one or more of the following marks as of the initial filing date of the present disclosure: UNIX® (a registered trademark of THE OPEN GROUP LIMITED (PRIVATE LIMITED BY SHARES; ENGLAND AND WALES, UNITED KINGDOM)), LINUX® (a registered trademark of TORVALDS, LINUS (INDIVIDUAL; USA)), MICROSOFT WINDOWS® (a registered trademark of Microsoft Corporation (CORPORATION; WASHINGTON, USA)), or the like. More specifically, the instructions may cause various manipulations and operations on data stored in a storage device 210 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 202 is operatively coupled to a communication interface 206 such that the server system 200 can communicate with remote devices such as a computing device 300 (shown in FIG. 3) or another server system. For example, the communication interface 206 may receive communications from one or more of the data sources 12 or one or more of the client computing devices 20 via the communications network 10, as illustrated in FIG. 1.

The processor 202 is operatively coupled to the storage device 210. The storage device 210 may be any computer-operated hardware suitable for storing and/or retrieving data. In some embodiments, the storage device 210 is integrated in the server system 200. In other embodiments, the storage device 210 is external to the server system 200. The storage device 210 may be similar to the database 16. The server system 200 may include one or more hard disk drives as the storage device 210. The storage device 210 may be external to the server system 200 and may be accessed by a plurality of server systems 200. For example, the storage device 210 may include multiple storage units such as hard disks or solid-state disks in a redundant array of inexpensive disks (RAID) configuration. The storage device 210 may include a storage area network (SAN) and/or a network attached storage (NAS) system.

In some embodiments, the processor 202 is operatively coupled to the storage device 210 via a storage interface 208. The storage interface 208 is any component capable of providing the processor 202 with access to the storage device 210. The storage interface 208 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the storage device 210.

The processor 202 may include electronic hardware components such as one or more processors. The processor 202 may include one or more digital processing units. The processor 202 may include one or more microprocessors (single-core and multi-core), microcontrollers, digital signal processors (DSPs), field-programmable gate arrays (FPGAs), analog and/or digital application-specific integrated circuits (ASICs), or the like, or combinations thereof. The processor 202 may generally execute, process, or run instructions, code, code segments, software, firmware, programs, applications, apps, processes, services, daemons, or the like. The processor 202 may also include hardware components such as finite-state machines, sequential and combinational logic, and other electronic circuits that can perform the functions necessary for the operation of embodiments of the current invention. The processor 202 may be in communication with the other electronic components through serial or parallel links that include universal busses, address busses, data busses, control lines, and the like.

Through hardware, software, firmware, or combinations thereof, the processor 202 may be configured or programmed to perform the following functions. The processor 202 may execute the dynamic monitoring software (as described throughout this disclosure) to apply the laws of thermodynamics in monitoring the dynamics of A2A transaction systems.

### Exemplary Computing Device

FIG. 3 is an example configuration of a computing device 300 operated by a user 301. In some embodiments, the computing device 300 is data source 12 (shown in FIG. 1) and/or a client computing device 20 (shown in FIG. 1). In the example embodiment, the computing device 300 includes a processor 302 for executing instructions. In some embodiments, executable instructions are stored in a memory device 304. The processor 302 includes one or more processing units, for example, a multi-core configuration. The memory device 304 is any device allowing information such as dynamic metric visualization data, executable instructions, and/or written works to be stored and retrieved. The memory device 304 includes one or more computer readable media.

The processor 302 may include electronic hardware components such as one or more processors. The processor 302 may include one or more digital processing units. The processor 302 may include one or more microprocessors (single-core and multi-core), microcontrollers, digital signal processors (DSPs), field-programmable gate arrays (FPGAs), analog and/or digital application-specific integrated circuits (ASICs), or the like, or combinations thereof. The processor 302 may generally execute, process, or run instructions, code, code segments, software, firmware, programs, applications, apps, processes, services, daemons, or the like. The processor 302 may also include hardware components such as finite-state machines, sequential and combinational logic, and other electronic circuits that can perform the functions necessary for the operation of embodiments of the current invention. The processor 302 may be in communication with the other electronic components through serial or parallel links that include universal busses, address busses, data busses, control lines, and the like.

The computing device 300 also includes at least one media output component 306 for presenting information to the user 301. The media output component 306 is any component capable of conveying information to the user 301. In some embodiments, the media output component 306 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

The computing device 300 may render a graphical user interface (GUI) that is presented to the user 301 via the media output component 306. The GUI may include one or more actionable items enabling the user 301 to select one or more user-selectable parameters via the input device 306. The one or more actionable items may include one or more buttons, one or more icons, drop-down menus, selectable textual descriptions, and the like. The user-selectable parameters may correspond to parameters or instructions for generating and/or analyzing one or more visualizations of dynamic metrics associated with transaction records. The user-selectable parameters may include, for example, a time period of interest, a transaction type, a total transaction mass, an average transaction mass, a total transaction velocity, an average transaction velocity, a transaction energy, one or more entities associated with the transaction records, an indication of potentially fraudulent transaction records, an indication of non-fraudulent transaction records, and the like.

In some embodiments, the computing device 300 includes an input device 308 for receiving input from the user 301. The input device 308 may include, for example, a touch sensitive panel, a touch pad, a touch screen, a stylus, a gyroscope, an accelerometer, a position detector, a keyboard, a pointing device, a mouse, or an audio input device. The input device 308 may enable the user 301 to select actionable items presented by the GUI via the media output component 306. A single component such as a touch screen may function as both an output device of the media output component 306 and the input device 308. The computing device 300 may also include a communication interface 310, which is communicatively connectable to a remote device such as the server system 14 (shown in FIG. 1) and/or the one or more data sources 12 (shown in FIG. 1). The communication interface 310 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 306 and, optionally, receiving and processing input from the input device 308. A user interface may include, among other possibilities, a web browser and a client application. Web browsers enable users, such as the user 301, to display and interact with media and other information typically embedded on a web page or a website from the server system 14. A client application allows the user 301 to interact with a server application from the server system 14.

In the example embodiment, the computing device 300 is a user computing device from which the user 301 engages with a server system 14 to apply the laws of thermodynamics in monitoring the dynamics of A2A transaction systems. The user 301 may select one or more of the user-selectable parameters presented on the GUI. The server system 14 may send one or more visualizations to the computing device 300. The visualization(s) may include dynamic metrics associated with transaction records based on the user-selectable parameters.

In one or more embodiments, the visualization(s) may be analyzed by the user 301 to determine patterns of fraud associated with the transaction records. In one or more embodiments, the visualizations may also or alternatively be automatically analyzed by a computing device, such as the server system 14 or the computing device 300. The computing device 300 and/or server system 14 may include one or more machine learning models trained to detect patterns of fraud based on the visualizations. Additionally or alternatively, the one or more machine learning models may be trained to analyze the dynamic metrics to determine patterns of fraud. In some embodiments, the one or more machine learning models may be trained to predict patterns of fraud based on previously detected patterns identified based on the dynamic metrics and/or the visualizations. The one or more machine learning models may include, for example, an artificial neural network (ANN), a convolutional neural network (CNN), a recurrent neural network (RNN), a long short-term memory (LSTM) network, or the like. The machine learning model may be trained using supervised learning, unsupervised learning, reinforcement learning, semi-supervised learning, or the like.

### Exemplary Visualizations

In various embodiments, a server system, such as the server system 14 (shown in FIG. 1), may generate one or more visualization(s) depicting dynamic metrics of transaction records. The dynamic metrics may include a transaction mass, a transaction velocity, and/or a transaction energy. Each transaction mass, transaction velocity, and transaction energy may be associated with one or more transaction mass values, transaction velocity values, and transaction energy values, respectively. The server system may generate the visualization(s) based on user-selectable parameters. The user-selectable parameters may include a total transaction mass, a total transaction velocity, a total transaction energy, an average transaction mass, an average transaction velocity, an average transaction energy, a time period of interest associated with a timestamp of each transaction record, one or more customer IDs, and/or one or more organization IDs. In one or more embodiments, the server system may generate a default set of one or more visualizations if no selection or less than a complete set of selections for the user-selectable parameters is received. The fraud flag may include a fraud flag value. In some embodiments, for example, the fraud flag value may be zero (0) or one (1), as described below.

The visualization(s) may enable patterns of fraudulent transactions in A2A transaction systems to be analyzed in comparison to legitimate transactions. The visualizations may enable patterns of fraud to be evaluated in real time with minimal computational overhead by calculating and depicting the dynamic metrics of the transaction records according to the laws of thermodynamics. It would be appreciated by one of ordinary skill in the art that the visualizations may be analyzed for patterns of fraud either manually by a human operator or automatically by computing software, such as a machine learning algorithm (as described above).

FIGS. 4A and 4B depict various example visualizations of a transaction mass with respect to time. The visualizations may be generated by a server system, such as the server system 14 (shown in FIG. 1). The transaction mass may include a sum of an amount transacted over one or more time periods (e.g. a year-month, as shown). The example visualizations depict a first transaction mass over time associated with potentially fraudulent transaction records and a second transaction mass over time associated non-fraudulent transaction records.

FIG. 4A depicts an example visualization of a total transaction mass. The total transaction mass includes a total dollar amount transacted over time. In the example visualization, transaction records having a fraud flag value of one (1) are those considered to be potentially fraudulent transaction records. Transaction records having a fraud flag value of zero (0) are those considered to be non-fraudulent transaction records. The example visualization shows that potentially fraudulent transaction records have a net negative total transaction mass value, while the legitimate transactions have a net value of around zero (0).

FIG. 4B depicts an example visualization of an average transaction mass. The average transaction mass includes an average dollar amount transacted over time. In the example visualization, transaction records having a fraud flag value of one (1) are those considered to be potentially fraudulent transaction records. Transaction records having a fraud flag value of zero (0) are those considered to be non-fraudulent transaction records. The example visualization shows that the potentially fraudulent transaction records have a relatively large variation in average transaction mass over time compared to the non-fraudulent transaction records, which remain relatively stable.

FIGS. 5A and 5B depict various example visualizations of a transaction velocity with respect to time. The example visualization may be generated by a server system, such as the server system 14 (shown in FIG. 1). The transaction velocity may include a count of a number of transactions over one or more time periods (e.g. a year-month, as shown). The example visualizations depict a first transaction velocity associated with potentially fraudulent transaction records and a second transaction velocity associated with non-fraudulent transaction records.

FIG. 5A depicts an example visualization of a total transaction velocity. The total transaction velocity includes a total number of transactions over time. In the example visualization, transaction records having a fraud flag value of one (1) are those considered to be potentially fraudulent transaction records. Transaction records having a fraud flag value of zero (0) are those considered to be non-fraudulent transaction records. The example visualization shows that potentially fraudulent transaction records have a significantly lower velocity value over time compared to the non-fraudulent transaction records.

FIG. 5B depicts an example visualization of an average transaction velocity. The average transaction velocity includes an average number of transactions over time. In the example visualization, transaction records having a fraud flag value of one (1) are those considered to be potentially fraudulent transaction records. Transaction records having a fraud flag value of zero (0) are those considered to be non-fraudulent transaction records. The example visualization shows that potentially fraudulent transaction records have a relatively large variation in average transaction velocity over time compared to non-fraudulent transaction records, which appear to increase at a relatively steady rate.

### Exemplary Computer-Implemented Methods

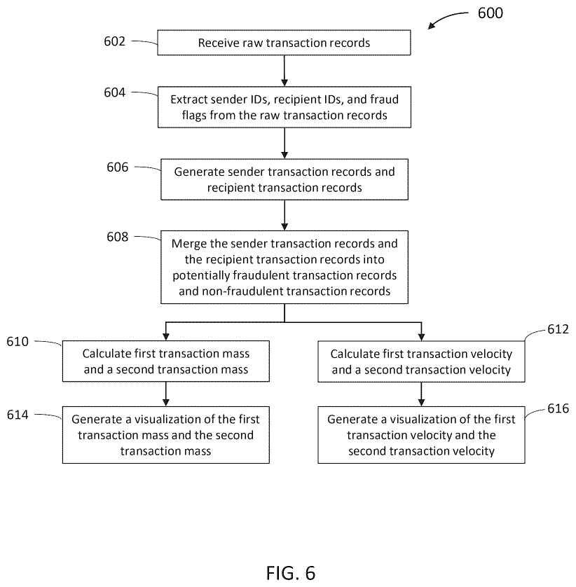

FIG. 6 depicts a listing of steps of an exemplary computer-implemented method 600 for applying the laws of thermodynamics in monitoring the dynamics of account-to-account (A2A) transaction systems. The steps may be performed in the order shown in FIG. 6, or they may be performed in a different order. Furthermore, some steps may be performed concurrently as opposed to sequentially. In addition, some steps may be optional.

The computer-implemented method 600 is described below, for ease of reference, as being executed by exemplary devices and components introduced with the embodiments illustrated in FIGS. 1-3. For example, the steps of the computer-implemented method 600 may be performed by the data sources 12, the server system 14, the client computing devices 20, and the network 10 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. For example, the steps performed by the server system 14 may be performed in whole or in part by a load balancer of a web service system without departing from the spirit of the present invention.

One or more computer-readable medium(s) may also be provided. The computer-readable medium(s) may include one or more executable programs stored thereon, such as the dynamic transaction monitoring software, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 602, raw transaction records may be received by a server system from one or more data sources. In one or more embodiments, the server system 14 and one or more data sources 12 may perform step 602. The raw transaction records may correspond to financial transactions associated with A2A transaction systems. The raw transaction records may be transmitted by the data sources on a periodic basis, such as monthly, weekly, or daily. The raw transaction records may also or alternatively be transmitted in real time. Each raw transaction record may describe a respective financial transaction in which currency is transferred from a sender, or sending account, to a recipient, or recipient account. Each raw transaction record may include transaction data including a transaction type, a timestamp, a sender identifier (ID), a recipient identifier (ID), a sender organization identifier (ID), a recipient organization identifier (ID), a transaction amount, a fraud flag, and the like.

The transaction type may identify one or more transaction records as deriving from one of an A2A type transaction, a P2P type transaction, a B2B type transaction, or the like. In a preferred embodiment, the raw transaction records are A2A type transactions. The timestamps may include a date, month, year, and/or exact time of the transaction. The sender ID may uniquely identify one or more senders associated with one or more financial transactions. The recipient ID may uniquely identify one or more recipients associated with the one or more financial transactions. The sender organization ID may uniquely identify a financial institution or entity in which the sender holds one or more accounts associated with the one or more financial transactions. The recipient organization ID may uniquely identify a financial institution or entity in which the recipient holds one or more accounts associated with the one or more financial transactions. The transaction amount may correspond to an amount of currency transferred from the sending account to the recipient account. The fraud flag may indicate a likelihood of fraud being associated with a given transaction record. The fraud flag may have a fraud flag value of zero (0) or one (1). A fraud flag value of zero (0) may identify non-fraudulent transaction records. A fraud flag value of one (1) may identify potentially fraudulent transaction records. The potentially fraudulent transaction records may be likely associated with fraud or confirmed as being associated with fraud. One of ordinary skill will appreciate that any form of flag value or other indicator may be used for such fraud likelihood identification within the scope of the present invention.

In one or more embodiments, the raw transaction records may be encrypted by the data source(s) using a private key of a public/private key pair associated with the data source(s). The server system may decrypt the raw transaction records using a public key of the public/private key pair associated with one or more of the data sources. It would be appreciated by one of ordinary skill in the art that various encryption devices and techniques, such as advanced encryption standard (AES) algorithm(s), hardware security module(s) (HSM), symmetric encryption algorithm(s), asymmetric encryption algorithm(s), Rivest-Shamir-Adleman (RSA) encryption algorithms, hybrid encryption algorithm(s), and the like, may be employed in one or more embodiments.

Referring to step 604, the server system may extract relevant information from each raw transaction record. In one or more embodiments, the extraction is performed by the server system 14. The extracted information may include the transaction types, the timestamps, the sender IDs, the recipient IDs, the sender organization IDs, the recipient organization IDs, the transaction amounts, the fraud flags, a sender transaction count, and a recipient transaction count. The extracted information may include potentially fraudulent extracted information and non-fraudulent extracted information, as indicated by fraud flag values of the extracted fraud flags. The timestamps may include a month and a year. The month and the year may be extracted as separate data fields. Alternatively, the month and the year may be extracted as a single data field. The timestamps may also or alternatively include an exact date and time and may be extracted into separate data fields or a single data field. The sender transaction count may include a number of transactions corresponding to a respective sender ID. The recipient transaction count may include a number of transactions corresponding to a recipient ID.

Referring to step 606, the raw transaction records may be separated into sender transaction records and recipient transaction records based on the extracted information. In one or more embodiments, the separation is performed by the server system 14. The sender transaction records may include non-fraudulent sender transaction records and potentially fraudulent sender transaction records. The recipient transaction records may include non-fraudulent recipient transaction records and potentially fraudulent recipient transaction records. In particular, the extracted information may be separated based on the sender IDs, the recipient IDs, and the fraud flag values. The server system may identify the non-fraudulent sender transaction records, the potentially fraudulent sender transaction records, the non-fraudulent recipient transaction records, and the potentially fraudulent recipient transaction records from the extracted information based on the fraud flags included in the extracted information.

The server system may generate combined sender transaction records based on or including the non-fraudulent sender transaction records and the potentially fraudulent sender transaction records. Each of the combined sender transaction records may include a fraud flag, a sender transaction count, and a sender ID. The sender transaction counts may indicate a number of financial transactions associated with each combined sender transaction record.

The combined sender transaction records may include combined potentially fraudulent sender records generated based on the potentially fraudulent sender transaction records and combined non-fraudulent sender transaction records generated based on the non-fraudulent sender transaction records. The server system may generate the combined non-fraudulent sender transaction records based on the non-fraudulent sender records. Each combined non-fraudulent sender transaction record may include an aggregation of non-fraudulent sender transaction records associated with a particular sender ID. Each combined potentially fraudulent sender transaction record may include an aggregation of potentially fraudulent sender transaction records associated with a particular sender ID.

The server system may generate combined recipient transaction records based on or including the non-fraudulent recipient transaction records and the potentially fraudulent recipient transaction records. Each of the combined recipient transaction records may include a fraud flag, a recipient transaction count, and a recipient ID. The recipient transaction counts may indicate a number of financial transactions associated with each combined recipient transaction record.

The combined recipient transaction records may include combined potentially fraudulent recipient records generated based on the potentially fraudulent recipient transaction records and combined non-fraudulent recipient transaction records generated based on the non-fraudulent recipient transaction records. The server system may generate the combined non-fraudulent recipient transaction records based on the non-fraudulent recipient records. Each combined non-fraudulent recipient transaction record may include an aggregation of non-fraudulent recipient transaction records associated with a particular recipient ID. Each combined potentially fraudulent recipient transaction record may include an aggregation of potentially fraudulent recipient transaction records associated with a particular recipient ID.

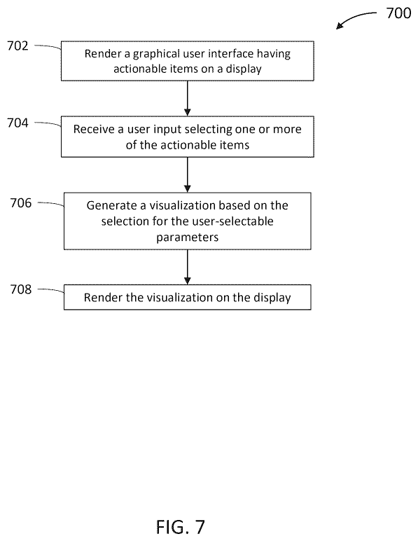

In one or more embodiments, the server system may further delineate or separate the combined sender transaction records and the combined recipient transaction records based on one or more time periods. For example, a first combined sender transaction record may be a combined non-fraudulent sender transaction record including an aggregation of non-fraudulent sender transaction records associated with a first sender ID and a first time period. A second combined sender transaction may be a combined potentially fraudulent sender transaction record including an aggregation of potentially fraudulent sender transaction records associated with the first sender ID and the first time period. A third combined sender transaction record may be a potentially fraudulent sender transaction including an aggregation of potentially fraudulent sender transaction records associated with the first sender ID and a second time period subsequent to the first time period. The server system may identify one or more time periods associated with extracted information based on the extracted timestamps. The time periods may or may not overlap and may include a day, a month, a year, and/or a user-selectable time range. In some embodiments, the time period(s) may be a user-selectable parameter, as described in reference to FIG. 7.

In one or more embodiments, the extracted information may also or alternatively be separated according to the sender organization IDs and the recipient organization IDs. The server system may identify and combine sender transaction records having matching sender organization IDs and matching fraud flags for each of one or more time periods. Non-fraudulent sender transaction records having matching sender organization IDs may be aggregated into combined non-fraudulent sender transaction records for each of the time period(s). Potentially fraudulent sender transaction records having matching sender organization IDs may be aggregated into respective combined potentially fraudulent sender transaction records for each of the time period(s). Each sender organization ID may be associated with a respective one or more of the transaction counts. The sender transaction counts may indicate a number of potentially fraudulent sender transaction records and/or a number of non-fraudulent sender transaction records associated with each respective sender organization ID for each of the time period(s).

The server system may also or alternatively identify and combine recipient transaction records having matching recipient organization IDs and matching fraud flags for each of one or more time period(s). Non-fraudulent recipient transaction records having matching recipient organization IDs may be aggregated into respective combined non-fraudulent recipient transaction records for each of the time period(s). Potentially fraudulent recipient transaction records having matching recipient organization IDs may be aggregated into respective combined potentially fraudulent transaction records for each of the time period(s). Each recipient organization ID may be associated with a respective one or more of the recipient transaction counts. The recipient transaction counts may indicate a number of potentially fraudulent recipient transaction records and/or a number of non-fraudulent recipient transaction records associated with each respective recipient organization ID for each of the time period(s).

Referring to step 608, the server system 14 may generate merged transaction records based on the combined sender transaction records and the combined recipient transaction records. The merged transaction records may include potentially fraudulent transaction records and non-fraudulent transaction records. The merging may be based on the recipient IDs, the sender IDs, and the fraud flags included in the combined sender transaction records and combined recipient transaction records. The merged transaction records may each include a customer identifier (ID), an organization identifier (ID), a time period (e.g. a year-month), an amount of currency received, an amount of currency sent, a recipient transaction count, a sender transaction count, a fraud flag, a transaction mass value, a transaction velocity value, and a transaction energy value.

More particularly, the potentially fraudulent transaction records of the merged transaction records may be generated by merging the combined potentially fraudulent sender transaction records of the combined sender transaction records with the combined potentially fraudulent recipient transaction records of the combined recipient transaction records. The non-fraudulent transaction records of the merged transaction records may be generated by merging the combined non-fraudulent sender transaction records of the combined sender transaction records with the combined non-fraudulent recipient transaction records of the combined recipient transaction records.

In a preferred embodiment, the server system may identify matching sender ID and recipient ID pairs from the combined sender transaction records and the combined recipient transaction records. A matched sender ID and recipient ID pair may be associated with a single account holder. The account holder may be an individual and/or an organization, such as a business, school, and the like. The values or strings comprising a matched sender ID and recipient ID pair may be merged to form a respective customer ID. In one or more embodiments, the matched sender ID and recipient ID may be identical. Each customer ID may be identical to a respective one of the sender ID and recipient ID pairs. In an alternative embodiment, only a portion of the matched sender ID and recipient ID may be identical to the corresponding customer ID. The customer ID may reflect values, strings or patterns in the sender ID, the recipient ID, or an assigned customer ID. In one or more embodiments, the sender IDs, recipient IDs, and customer IDs may correspond to a primary account number (PAN), a credit card number, a debit card number, a tokenized account identifier, a user-generated identifier, a randomly generated number, or the like.

In one or more embodiments, the server system may identify matching sender organization ID and recipient organization ID pairs. Each matched sender organization ID and recipient organization ID pair may correspond to a respective financial institution. The values or strings comprising each matched sender organization ID and recipient organization ID pair may be merged to form the corresponding organization ID. In one or more embodiments, the matched sender organization IDs and recipient IDs may be identical. Alternatively, only a portion the matched sender organization IDs and recipient organization IDs may be identical. In one or more embodiments, sender organization IDs and recipient organization IDs, and merged organization IDs may include, for example, bank identification numbers (BINs).

In one or more embodiments, the server system merges the combined sender transaction records with the combined recipient transactions and based on matching customer IDs and fraud flag values for each time period. Merging the combined sender transaction records with the combined recipient transaction records according to the time periods, in addition to the customer IDs and fraud flags, provides a basis for generating visualizations for monitoring the dynamics of A2A transaction systems using the laws of thermodynamics. analyzing fraudulent transaction behaviors with respect to time. The time period(s) may be a year-month (as shown in FIGS. 4A, 4B, 5A, and 5B). In one or more embodiments, the time period(s) may correspond to one or more time periods of interest as indicated by a user.

In a preferred embodiment, the server system may calculate dynamic metrics, including respective transaction mass values, transaction velocity values, and transaction energy values, for each potentially fraudulent transaction record and each non-fraudulent transaction record. The transaction mass values may include a sum of the amount of currency sent and the amount of currency received for each potentially fraudulent transaction record and non-fraudulent transaction record. The transaction velocity values may include a sum of the sender transaction count and the recipient transaction count for each potentially fraudulent transaction record and non-fraudulent transaction record. The energy values may include one half of the transaction mass value multiplied by the square of the transaction velocity value for each potentially fraudulent transaction record and non-fraudulent transaction record.

Referring to step 610, the server system may calculate, for each time period, a first transaction mass corresponding to the potentially fraudulent transaction records and a second transaction mass corresponding to the non-fraudulent transaction records. In one or more embodiments, the calculation is performed by the server system 14. The first transaction mass may include respective sums of the transaction mass values of the potentially fraudulent transaction records for each time period (as best shown in FIG. 4A). The second transaction mass may include respective sums of the transaction mass values of the non-fraudulent transaction records for each time period (as best shown in FIG. 4A).

In one or more embodiments, the first transaction mass may include respective averages of the transaction mass values of the potentially fraudulent transaction records for each time period (as best shown in FIG. 4B). The second transaction mass may include respective averages of the transaction mass values of the non-fraudulent transaction records for each time period (as best shown in FIG. 4B).

In one or more embodiments, multiple transaction mass values may be calculated for each time period based on respective organization IDs, such that each organization ID is associated with one transaction mass value for each time period. In some embodiments, an aggregate transaction mass may be calculated in addition to the first and second transaction masses. The aggregate transaction mass may include a first sum of the transaction mass values of the potentially fraudulent transaction records and a second sum of the transaction mass values of the non-fraudulent transaction records.

Referring to step 612, the server system may calculate, for each time period, a first transaction velocity corresponding to the potentially fraudulent transaction records and a second transaction velocity corresponding to the non-fraudulent transaction records. In one or more embodiments, the calculation is performed by the server system 14. In one or more embodiments, the first transaction velocity may include a sum of the transaction velocity values of the potentially fraudulent transaction records for each time period (as best shown in FIG. 5A). The second transaction velocity may include a sum of the transaction velocity values of the non-fraudulent transaction records for each time period (as best shown in FIG. 5A). The first transaction velocity may include an average of the transaction velocity values of the potentially fraudulent transaction records for each time period (as best shown in FIG. 5B). The second transaction velocity may include an average of the transaction velocity values of the non-fraudulent transaction records for each time period (as best shown in FIG. 5B).

In one or more embodiments, multiple transaction velocity values may be calculated for each time period based on respective organization IDs, such that each organization ID is associated with one transaction velocity value for each time period. In some embodiments, an aggregate transaction velocity may be calculated in addition to the first and second transaction velocities. The aggregate transaction velocity may include a first sum of the transaction velocity values of the potentially fraudulent transaction records and a second sum of the transaction velocity values of the non-fraudulent transaction records.

Additionally, the server system may calculate, for each of the time periods, a first transaction energy corresponding to the potentially fraudulent transaction records and a second transaction energy corresponding to the non-fraudulent transaction records. In one or more embodiments, the first transaction energy may include respective sums of the transaction energy values of the potentially fraudulent transaction records for each time period. The second transaction energy may include respective sums of the transaction energy values of the non-fraudulent transaction records for each time period. The first transaction energy may include respective averages of the transaction energy values of the potentially fraudulent transaction records for each time period. The second transaction energy may include respective averages of the transaction energy values of the non-fraudulent transaction records for each time period.

In one or more embodiments, multiple transaction energy values may be calculated for each time period based on respective organization IDs, such that each organization ID is associated with one transaction energy value for each time period. In some embodiments, an aggregate transaction energy may be calculated in addition to the first and second transaction velocities. The aggregate transaction energy may include a first sum of the transaction energy values of the potentially fraudulent transaction records and a second sum of the transaction energy values of the non-fraudulent transaction records.

Referring to step 614, the server system may generate one or more visualizations of the first transaction mass and the second transaction mass. In one or more embodiments, the generation is performed by the server system 14. The visualization(s) may include a total transaction mass over time (as best shown in FIG. 4A). The visualization(s) may include an average transaction mass over time (as best shown in FIG. 4B).

In one or more embodiments, a first visualization corresponding to the total transaction mass and a second visualization corresponding to the average transaction mass may be generated.

In one or more embodiments, the server system may establish communication with one or more client devices via a communication network for serving the visualization(s) to one or more of the client computing devices. In one or more embodiments, the server system 14 establishes communication with client device(s) 20 via the communication network 10. The server system may send the visualization(s) to the client computing device. The visualization(s) may be rendered on a display (e.g. media output component 306) of one or more of the client computing devices.

Referring to step 616, the server system may generate one or more visualization(s) of the first transaction velocity and the second transaction velocity. In one or more embodiments, the generation is performed by the server system 14. The visualization(s) may include a total transaction velocity over time (as best shown in FIG. 5A). In another embodiment, the visualization(s) may include an average transaction velocity over time (as best shown in FIG. 5B). In one or more embodiments, a first visualization corresponding to the total transaction velocity and a second visualization corresponding to the average transaction velocity may be generated. In one or more embodiments, the server system 14 may establish communication with one or more of the client devices 20 via the communication network 10 for serving the visualization(s) to one or more of the client computing devices 20. The server system may send the visualization(s) to the client computing device. The visualization(s) may be rendered on the display of one or more of the client computing devices.

Additionally, the server system may generate one or more visualization(s) of the first transaction energy and the second transaction energy. The visualization(s) may include a total transaction energy over time. The visualization may include an average transaction energy over time. A first visualization corresponding to the total transaction energy and a second visualization corresponding to the average transaction energy may be generated. In one or more embodiments, the server system may establish communication with one or more of the client devices via the communication network for serving the visualization(s) to one or more of the client computing devices. The server system may send the visualization(s) to the client computing device. The visualization(s) may be rendered on the display of one or more of the client computing devices.

In one or more embodiments, the visualization(s) may be generated by the server system based on received selections of user-selectable parameters, as is described below in reference to FIG. 7. Also or alternatively, the server system may generate one or more default visualizations if no selection or an incomplete selection of user-selectable parameters is received.

The method 600 may include additional, less, or alternate actions, including those discussed elsewhere herein such as in the sections entitled “Exemplary System,” “Exemplary Server System,” “Exemplary Computing Device,” and “Exemplary Visualizations” and/or may be implemented via a computer system, communication network, one or more processors or servers, and/or computer-executable instructions stored on non-transitory storage media or computer readable medium.

FIG. 7 depicts a listing of steps of an exemplary computer-implemented method 700 for applying the laws of thermodynamics in monitoring the dynamics of account-to-account (A2A) transaction systems. The steps may be performed in the order shown in FIG. 7, or they may be performed in a different order. Furthermore, some steps may be performed concurrently as opposed to sequentially. In addition, some steps may be optional.

The computer-implemented method 700 is described below, for ease of reference, as being executed by exemplary devices and components introduced with the embodiments illustrated in FIGS. 1-3. For example, the steps of the computer-implemented method 700 may be performed by the data sources 12, the server system 14, the client computing devices 20, and the network 10 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. For example, the steps performed by the server system 14 may be performed in whole or in part by a load balancer of a web service system without departing from the spirit of the present invention.

One or more computer-readable medium(s) may also be provided. The computer-readable medium(s) may include one or more executable programs stored thereon, such as the dynamic transaction monitoring software, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 702, a graphical user interface (GUI) is rendered on a display (e.g. the media output 306) of a computing device, such as one or more of the client computing devices 20. The GUI may include one or more actionable items. The one or more actionable items may include one or more buttons, one or more icons, a drop-down menu, selectable textual descriptions, and the like. The actionable item(s) may represent one or more user-selectable parameters. The user-selectable parameter(s) may correspond to parameters of visualizations depicting dynamic metrics associated with transaction records (as shown in FIGS. 4A, 4B, 5A, 5B, and described in reference to FIG. 6). The one or more actionable items may enable a user to select one or more of the user-selectable parameter(s). The user-selectable parameter(s) may include, for example, one or more time periods of interest, a transaction type, a total transaction mass, an average transaction mass, a total transaction velocity, an average transaction velocity, a total transaction energy, an average transaction energy, one or more organization IDs, a fraud flag indication, one or more specific customer IDs, and the like.

Referring to step 704, a user input may be received via an input device (e.g. the input device 308). The user input may include a selection of one or more of the user-selectable parameter(s). Referring to step 706, the server system and/or the client computing device 20 may generate one or more visualizations based on the selection of the user-selectable parameters, including, for example, in the manner described above in connection with method 600.

Referring to step 708, the one or more visualizations are rendered on the display. The visualization may be displayed in a user-selectable arrangement. The user-selectable arrangement may include additional actionable items. The additional actionable items may advantageously enable a user to analyze and manipulate (e.g., overlay, with or without automatically adjusting opacity, or otherwise manipulate) a plurality of visualizations individually or simultaneously to identify patterns of fraudulent behavior. The user-selectable arrangement of the visualizations may enable the user to efficiently identify patterns of fraudulent behavior in real time without requiring complex or cost intensive computations.

The method 700 may include additional, less, or alternate actions, including those discussed elsewhere herein such as in the sections entitled “Exemplary System,” “Exemplary Server System,” “Exemplary Computing Device,” and “Exemplary Visualizations” and/or may be implemented via a computer system, communication network, one or more processors or servers, and/or computer-executable instructions stored on non-transitory storage media or computer readable medium.

Advantageously, embodiments of the present invention enable a computationally efficient means to monitor dynamic metrics of A2A transaction systems in real time. Applying the laws of thermodynamics to calculate the dynamic metrics enables patterns of fraudulent transactions to be analyzed in real time while minimizing computational complexity, which, in turn, reduces power consumption and operating costs associated with otherwise computationally complex systems.

### Additional Considerations

In this description, references to “one embodiment,” “one or more embodiments,” or “embodiments” mean that the feature or features being referred to are included in at least one embodiment of the technology. Separate references to “one embodiment,” “one or more embodiments,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable medium having instructions stored thereon that, when executed by at least one processor, cause the at least one processor to:
receive, from a data source, raw transaction records corresponding to financial transactions, each of the raw transaction records including a sender identifier (ID), a recipient ID, a timestamp, an amount, and a fraud flag relating to a likelihood of fraud in the corresponding one of the financial transactions;
extract, from the raw transaction records, the sender ID, the recipient ID, and the fraud flag for each of the financial transactions;
generate, based on the sender ID, the recipient ID, and the fraud flag extracted for each of the raw transaction records: sender transaction records including non-fraudulent sender transaction records and potentially fraudulent sender transaction records;
and recipient transaction records including non-fraudulent recipient transaction records and potentially fraudulent recipient transaction records;
merge the sender transaction records and the recipient transaction records into potentially fraudulent transaction records and non-fraudulent transaction records;
calculate a first transaction mass of the potentially fraudulent transaction records for each sender ID and recipient ID and a second transaction mass of the non-fraudulent transaction records for each sender ID and recipient ID;
calculate a first transaction velocity of the potentially fraudulent transaction records and a second transaction velocity of the non-fraudulent transaction records;
generate a visualization comprising dynamic metrics including any combination of two (2) or more of the first transaction mass, the second transaction mass, the first transaction velocity, or the second transaction velocity, said visualization including a graphical representation of at least one pattern associated with the potentially fraudulent transaction records and the non-fraudulent transaction records;
analyze, with a machine learning model comprising a neural network, the visualization to identify a fraudulent pattern from the dynamic metrics; and
render the visualization on a display.

2. The non-transitory computer readable medium of claim 1,
the visualization including the first transaction mass and the second transaction mass.

3. The non-transitory computer readable medium of claim 2, wherein when executed by the at least one processor the computer-executable instructions further cause the at least one processor to:
render a graphical user interface (GUI) on the display, said GUI including actionable items for modifying user-selectable parameters;
receive a user input selecting one or more of the actionable items for setting the user-selectable parameters via the GUI; and
generate the visualization based on said selections for the user-selectable parameters.

4. The non-transitory computer readable medium of claim 3,
said user-selectable parameters including a time period of interest associated with a timestamp of each of the financial transactions, a total transaction mass, an average transaction mass, and an entity associated with each of the financial transactions.

5. The non-transitory computer readable medium of claim 1,
the visualization including the first transaction velocity and the second transaction velocity.

6. The non-transitory computer readable medium of claim 5, wherein when executed by the at least one processor the computer-executable instructions further cause the at least one processor to:
render a graphical user interface (GUI) on the display, said GUI including actionable items for modifying user-selectable parameters;
receive a user input selecting one or more of the actionable items for setting the user-selectable parameters via the GUI; and
generate the visualization based on said selections for the user-selectable parameters.

7. The non-transitory computer readable medium of claim 6,
said user-selectable parameters including a time period of interest associated with a timestamp of each of the financial transactions, a total transaction mass, an average transaction mass, and an entity associated with each of the financial transactions.

8. The non-transitory computer readable medium of claim 1, wherein generating the sender transaction records and the recipient transaction records includes:
aggregating those of the transaction records having matching sender IDs and matching corresponding ones of the fraud flags to generate the non-fraudulent sender transaction records and the potentially fraudulent sender transaction records; and
aggregating those of the transaction records having matching recipient IDs and matching corresponding ones of the fraud flags to generate the non-fraudulent recipient transaction records and the potentially fraudulent recipient transaction records.

9. The non-transitory computer readable medium of claim 1, wherein merging the sender transaction records and the recipient transaction records includes:
matching the sender IDs of the non-fraudulent sender transaction records and of the potentially fraudulent sender transaction records with the recipient IDs of the non-fraudulent recipient transaction records and of the potentially fraudulent recipient transaction records to generate an account ID for each match;
merging the non-fraudulent sender transaction records and the non-fraudulent recipient transaction records having matched account IDs to generate the non-fraudulent transaction records; and
merging the potentially fraudulent sender transaction records and the potentially fraudulent recipient transaction records having matched account IDs to generate the potentially fraudulent transaction records.

10. The non-transitory computer readable medium of claim 1,
said first transaction mass including a sum of the amounts of the non-fraudulent transaction records and said second transaction mass including a sum of the amounts of the potentially fraudulent transaction records;
said first transaction velocity including a transaction count of the non-fraudulent transaction records and said second transaction velocity including a transaction count of the potentially fraudulent transactions.

11. A computer-implemented method, comprising:
receiving, from a data source, raw transaction records corresponding to financial transactions, each raw transaction record including a sender identifier (ID), recipient ID, an amount, and a fraud flag relating to a likelihood of fraud in the corresponding one of the financial transactions;
extracting, from the raw transaction records, the sender ID, the recipient ID, and the fraud flag for each of the financial transactions;
generating, based on the sender ID, the recipient ID, and the fraud flag extracted for each of the raw transaction records: sender transaction records including non-fraudulent sender transaction records and potentially fraudulent sender transaction records; and recipient transaction records including non-fraudulent recipient transaction records and potentially fraudulent recipient transaction records;
merging the sender transaction records and the recipient transaction records into potentially fraudulent transaction records and non-fraudulent transaction records;
calculating a first transaction mass of the potentially fraudulent transaction records and a second transaction mass of the non-fraudulent transaction records;
calculating a first transaction velocity of the potentially fraudulent transaction records and a second transaction velocity of the non-fraudulent transaction records;
generating a visualization comprising dynamic metrics including any combination of two (2) or more of the first transaction mass, the second transaction mass, the first transaction velocity, or the second transaction velocity, said visualization including a graphical representation of at least one pattern associated with the potentially fraudulent transaction records and the non-fraudulent transaction records;
analyzing, with a machine learning model comprising a neural network, the visualization to identify a fraudulent pattern from the dynamic metrics; and
rendering the visualization on a display.

12. The computer-implemented method of claim 11,
the visualization including the first transaction mass and the second transaction mass.

13. The computer-implemented method of claim 12, further comprising:
rendering a graphical user interface (GUI) on the display, said GUI including actionable items for modifying user-selectable parameters;
receiving a user input selecting one or more of the actionable items for setting the user-selectable parameters via the GUI; and
generating the visualization based on said selections for the user-selectable parameters.

14. The computer-implemented method of claim 13,
said user-selectable parameters including a time period of interest associated with a timestamp of each of the financial transactions, a total transaction mass, an average transaction mass, and an entity associated with each financial transaction.

15. The computer-implemented method of claim 11,
the visualization including the first transaction velocity and the second transaction velocity.

16. The computer-implemented method of claim 15, further comprising:
rendering a graphical user interface (GUI) on the display, said GUI including actionable items for modifying user-selectable parameters;
receiving a user input selecting one or more of the actionable items for setting the user-selectable parameters via the GUI; and
generating the visualization based on said selections for the user-selectable parameters.

17. The computer-implemented method of claim 16,
said user-selectable parameters including a time period of interest associated with a timestamp of each of the financial transactions, a total transaction velocity, an average transaction velocity, and an entity associated with each of the financial transactions.

18. The computer-implemented method of claim 11, wherein generating the sender transaction records and the recipient transaction records includes:
aggregating those of the transaction records having matching sender IDs and matching corresponding ones of the fraud flags to generate the non-fraudulent sender transaction records and the potentially fraudulent sender transaction records; and
aggregating those of the transaction records having matching recipient IDs and matching corresponding ones of the fraud flags to generate the non-fraudulent recipient transaction records and the potentially fraudulent recipient transaction records.

19. The computer-implemented method of claim 11, wherein merging the sender transaction records and the recipient transaction records includes:
matching the sender IDs of the non-fraudulent sender transaction records and of the potentially fraudulent sender transaction records with the recipient IDs of the non-fraudulent recipient transaction records and of the potentially fraudulent recipient transaction records to generate an account ID for each match;
merging the non-fraudulent sender transaction records and the non-fraudulent recipient transaction records having matched account IDs to generate the non-fraudulent transaction records; and
merging the potentially fraudulent sender transaction records and the potentially fraudulent recipient transaction records having matched account IDs to generate the potentially fraudulent transaction records.

20. The computer-implemented method of claim 11,
said first transaction mass including a sum of the amounts of the non-fraudulent transaction records and said second transaction mass including a sum of the amounts of the potentially fraudulent transaction records;
said first transaction velocity including a transaction count of the non-fraudulent transaction records and said second transaction velocity including a transaction count of the potentially fraudulent transaction records.
